(19) United States
(12) Patent Application Publication
(10) Pub. No.: US 2007/0195102 A1
(43) Pub. Date: Aug. 23, 2007

(54) Switch unit with ventilation

(75) Inventor: Willem Jozef Lodewijk Marie Guislens Peters, Lommel (BE)

Correspondence Address: BANNER & WITCOFF, LTD., 1100 13th STREET, N.W., SUITE 1200, WASHINGTON, DC, 20005-4051, US

(73) Assignee: Electrische Apparatenfabriek Capax B.V., Eindhoven (NL)

(21) Appl. No.: 10/577,497

(22) PCT Filed: Nov. 5, 2004
(86) PCT No.: PCT/NL04/00781

§ 371 Date: Jan. 31, 2007

(30) Foreign Application Priority Data
Nov. 7, 2003 (NL) 1024744

(51) Int. Cl. G09G 5/36

(52) U.S. Cl. 345/553

(57) ABSTRACT

The invention relates to a switch unit for an electric tool, wherein the switch unit comprises heat-dissipating components, wherein the switch unit comprises a fan, which is adapted to cool the heat-dissipating components. The fan will herein generate an airflow which is guided via the relevant components. The heat developed in these components can be discharged so that the relevant components, even in the case of high power, can be given small dimensions. According to a particular preferred embodiment, the heat-dissipating components are thermally coupled to a cooling body, and the fan is adapted to cool the cooling body.

The present invention relates to an electrical switch unit for electric tools, wherein the switch unit comprises dissipating components.

Such switch units are generally known.

They form for instance a component of electric tools, and particularly of electric tools wherein the power of the (main) electric motor incorporated in the tool must be controlled. This includes among others, though not exclusively, drilling machines, sawing machines and the like.

The switch unit here includes components in which electrical energy is converted to heat during operation. These include semiconductors, resistors and so on.

This problem occurs with mains-powered tools, but also, and to a greater degree, in battery-powered tools. In this latter case the problem is caused in that because of the lower voltages the currents are greater, which generally results in a higher heat dissipation.

The heat dissipation affects the reliability of the electrical switch unit, can shorten the lifespan of the relevant components and can result in thermal deformation of the housing of the tool.

In order to prevent these problems, such components are dimensioned for high power so that they take up a relatively large amount of space.

The object of the present invention is to provide such a device wherein, while still maintaining the lifespan of the switch unit, the dimensions of the components, and thereby of the switch unit, can be reduced, and which can be produced at lower cost.

The object is achieved in that the switch unit comprises a fan which is adapted to cool at least the heat-dissipating components. Cooling can herein take place directly and indirectly, and the fan can contribute toward cooling of the (main) electric motor.

The fan will herein generate an airflow which is guided along the components in question. The heat developed in these components can be discharged so that the relevant components, even in the case of relatively high power, can be given small dimensions. Cooling preferably takes place locally which, with small fans and a concentrated airflow, can result in the desired cooling.

It is noted here that it is generally known in the field of computers to apply fans for the purpose of cooling heat-dissipating electronic components.

Despite that fact that an extremely high level of miniaturization has taken place in personal computers, they are still built into relatively large cabinets. The placing of such a fan can therefore generally take place without many problems.

In the case of electric tools the situation is different; here most space is available for the (main) electric motor, while only a limited space is available for the switch unit. The use of a fan in such a configuration is not therefore consistent with generally applicable assumptions.

It is further known from for instance DE-A-3,430,023 to cool the (main) electric motor of an electric (hand)tool with a fan placed in the voluminous part of the housing intended for the (main) electric motor, while the switch unit is arranged in a much narrower handgrip part of this housing, this narrower or smaller part being embodied without airflow discharge means, and the switch unit moreover comprises no heat-dissipating components. A cooling airflow does not run along the switch unit, which does not comprise any heat-dissipating component either, so that an airflow would not fulfil the need for cooling at the switch unit if such an airflow were to flow.

It is further noted that in the case of batteries or the like as power source for DC motors, forced cooling of the switch unit with a fan can provide a readily feasible alternative or addition for cooling of the (main) electric motor.

According to a particular preferred embodiment, the heat-dissipating components are thermally coupled to a cooling body, and the fan is adapted to cool the cooling body.

Depending on the relevant configuration of the switch unit, it is attractive in some situations to apply a cooling body. The invention therefore provides a measure for this purpose. The cooling herein takes place indirectly. It is of course possible to combine the cooling of the cooling body by the fan with the cooling of the components directly by the airflow from the fan.

The components do not dissipate heat in all situations of use of the electric tool. It is therefore attractive to have the degree of cooling depend on the amount of heat dissipated in these components. The relevant fan can then be controlled using a signal for representing power which is for instance already present in the switch unit and which represents the power, or by measuring the temperature of the components in question.

It is possible to place the fan in a wall of the housing of the switch unit. It is then attractive to place the fan upstream of the components for cooling in the airflow.

The present invention will be elucidated hereinbelow with reference to the accompanying figures, in which:

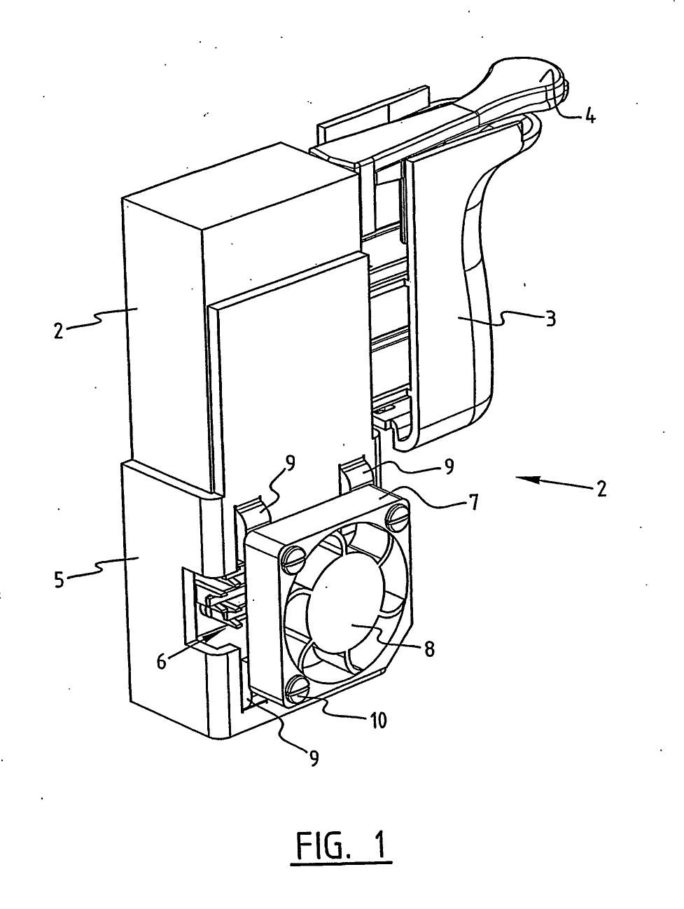

FIG. 1 shows a schematic perspective view of a switch unit provided with a fan;

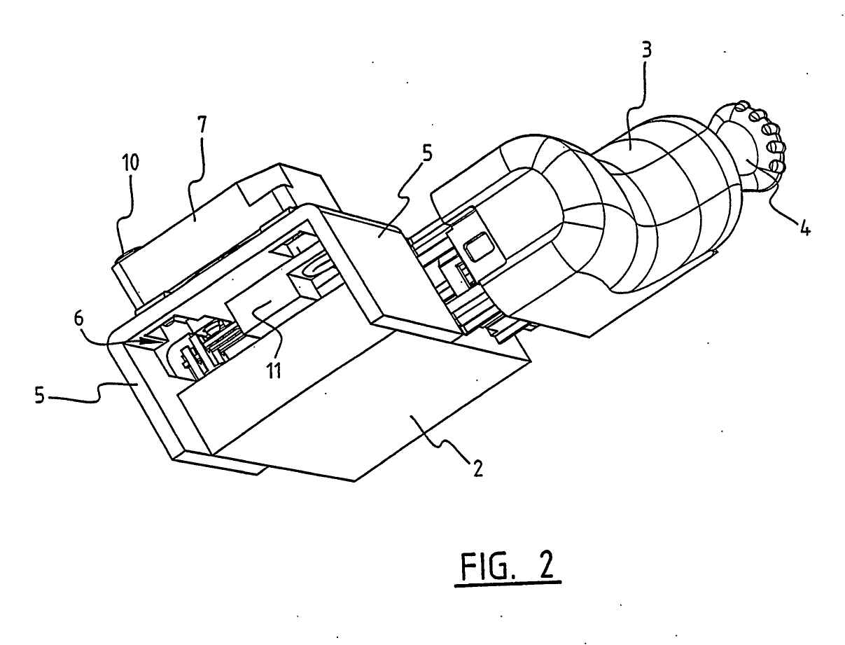

FIG. 2 is a schematic perspective view of the fan unit shown in FIG. 1 from a different angle;

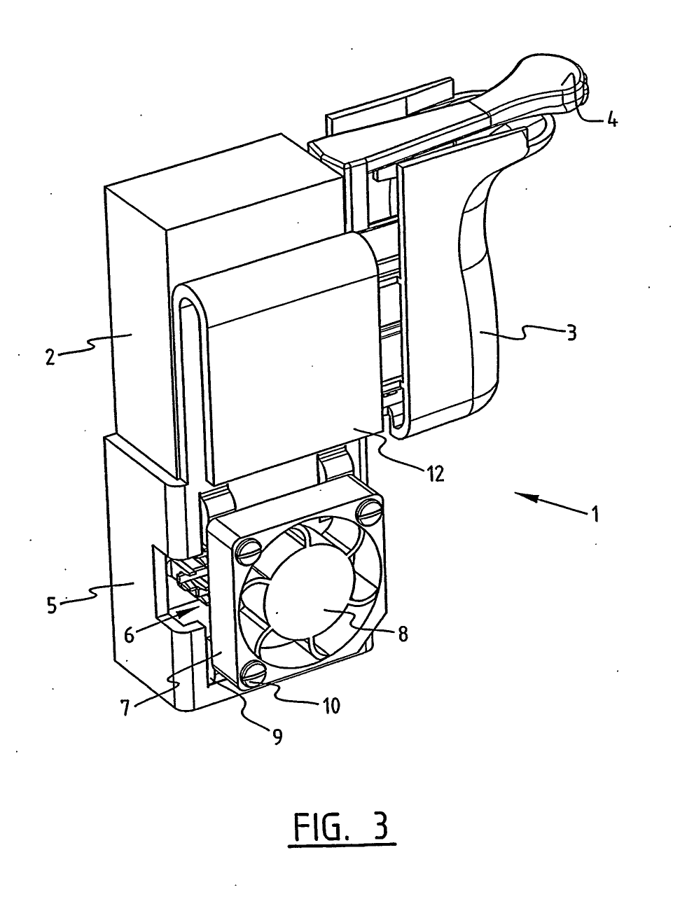

FIG. 3 shows a view corresponding with FIG. 1 of a second embodiment of a switch unit according to the present invention;

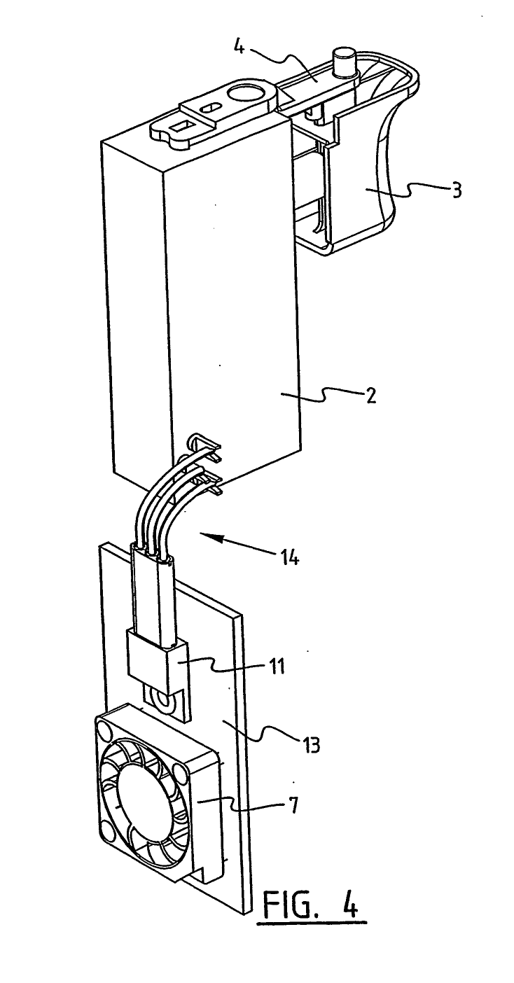

FIG. 4 shows a schematic perspective view of a third embodiment of a switch unit according to the present invention; and

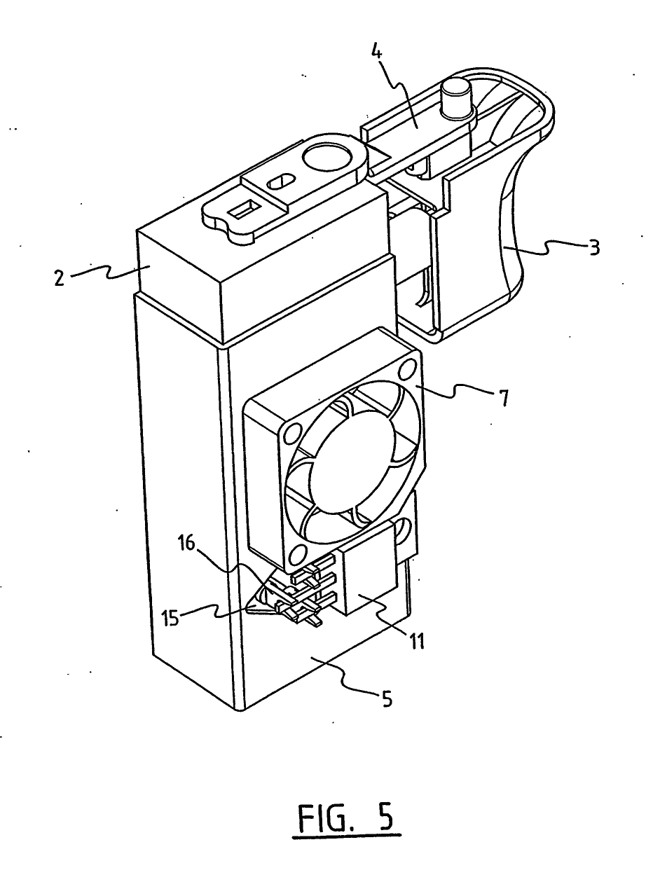

FIG. 5 is a schematic perspective view of a fourth embodiment according to the present invention.

FIG. 1 shows a switch unit designated in its entirety with reference 1. The switch unit comprises a housing 2 in which diverse components, including heat-dissipating components, are placed. A push-button 3 is arranged in per se known manner on the front side of the housing, while a handgrip 4 of a pole reverser switch is placed above the push-button.

A cooling plate 5 is arranged on one side of housing 2, and an opening 6 is arranged in cooling plate 5, while a fan unit 7 is placed on opening 6. Fan unit 7 comprises a combination of an electric motor and an impeller. The electric motor is not shown in this drawing since it is placed in the housing of fan unit 7. Impeller 8 is placed in fan housing 7. Placed in the cooling plate on either side of opening 6 are elevations 9 to which fan unit 7 is fixed by means of screws 10.

It will be apparent that numerous other possible fixing means can be applied.

The motor of fan unit 7 is connected by means of electrical conductors to appropriate voltage-carrying parts present in switch unit 1, so that fan unit 7 can begin to rotate at the relevant moments.

When fan unit 7 rotates it generates an airflow which is transmitted from the fan into the interior of the switch housing. The airflow then leaves the switch housing at the bottom.

The airflow here not only passes over heat-dissipating components arranged in the switch housing, such as semiconductor 11 in FIG. 2, but also over cooling plate 5. In the present exemplary embodiment this cooling plate 5 is thermally coupled to other heat-dissipating components, such as for instance resistors, not shown in the drawing. It is however possible to place a fan such that the generated airflow cools the components or the cooling body.

It is however possible in principle, by altering the position of the blades of impeller 8 or by changing the direction of rotation of the fan, to cause the airflow to displace in the other direction. In view of the fact that it is possible to place a filter in the fan in front of the airflow, the first mentioned option will generally be preferred.

FIG. 3 shows an embodiment of the invention which differs from the embodiment shown in FIGS. 1 and 2 in that cooling plate 5 takes a different form. Cooling plate 5 is herein provided with a bent portion 12. Owing to the bent portion 12 the cooling body 5 has a much larger cooling surface area than the cooling body 5 of the first embodiment according to FIG. 1 or FIG. 2. It is thus possible here to couple thermally to the cooling body components which are dimensioned for greater power.

As in the foregoing embodiment, fan unit 7 is placed slightly elevated relative to the main surface of cooling plate 5. This has the result that an air gap is present between the housing of fan unit 7 and the cooling plate. A part of the airflow generated by fan unit 7 will not therefore enter the housing but be displaced along the outer side of the cooling plate. The airflow will of course cool the cooling body here. Owing to the specific design of the embodiment shown in FIG. 3, this cooling effect will be even greater than in the embodiment shown in FIG. 1.

FIG. 4 shows a greatly differing embodiment of the invention; here a semiconductor 11 in which a relatively large amount of heat is dissipated is placed on a separate cooling body 13. Placed on the cooling body is a fan unit 7, the construction of which corresponds with that of the previous embodiments. The combination in question is however placed completely separately of switch housing 2, and is connected to the actual switch unit by means of three wires 14.

Owing to this separation of functions, it becomes easy to optimize cooling of the heat-dissipating semiconductor 11. An opening, not shown in the drawing, will herein be arranged in cooling body 13 for guiding the airflow generated by fan unit 7.

Finally, FIG. 5 shows an embodiment wherein the most significant heat-dissipating component, i.e. semiconductor 11, is placed on the outside of a cooling body 5. The construction of this embodiment otherwise corresponds in large measure with the construction of the embodiment described in FIGS. 1, 2 and 3. In the embodiment of FIG. 5 the fan unit 7 is placed directly on cooling body 5 so that an airflow generated by the fan unit will be displaced on the inner side of cooling body 5 and there carry out its cooling function. Here the heat-dissipating semiconductor 11 is of course coupled in thermally highly efficient manner to the cooling body. In cooling body 5 is arranged an opening 15 for passage of connecting pins 16 for connection of semiconductor 11. The airflow generated by fan unit 7 will not only cool the cooling body 5, but also the other heat-dissipating components arranged in the interior of housing 2.

It will be apparent that numerous variations of the configuration shown here can be applied without departing from the invention.

The fan can thus contribute toward cooling of the main motor of an electric (hand) tool or provide the whole of this cooling.

1. Electrical switch unit for an electric tool, wherein the switch unit comprises heat-dissipating components, characterized in that the switch unit comprises a fan which is adapted to cool the heat-dissipating components.

2. Switch unit as claimed in claim 1, characterized in that the fan is adapted to generate an airflow moving along the heat-dissipating components.

3. Switch unit as claimed in claim 1, characterized in that at least some of the heat-dissipating components is thermally coupled to a cooling body, and that the fan is adapted to cool the cooling body.

4. Switch unit as claimed in claim 3, characterized in that the fan is adapted to generate an airflow moving along the heat-dissipating components.

5. Switch unit as claimed in claim 1, characterized by a temperature sensor for controlling the fan subject to the temperature of the heat-dissipating components sensed by the temperature sensor.

6. Switch unit as claimed in claim 1, characterized by means for sending to the fan a signal representing power.

7. Switch unit as claimed in claim 1, characterized in that the fan is placed in a wall of the housing of the switch unit.

8. Switch unit as claimed in claim 1, characterized in that the fan is placed upstream of the components for cooling in the airflow.

9. Switch unit as claimed in claim 8, characterized in that a suction opening for air is arranged upstream of the fan in the housing of the tool.

10. Switch unit as claimed in claim 8, characterized in that the fan is adapted to generate an airflow extending through the motor of the tool.

11. Switch unit as claimed in claim 10, characterized in that the fan is adapted to generate a first and a second parallel airflow, the first of which cools the heat-dissipating components and the second of which is guided through the motor.

12. Electric tool comprising a switch unit according to claim 1.
